(19) United States
(12) Patent Application Publication
(10) Pub. No.: US 2026/0332757 A1
(43) Pub. Date: Oct. 22, 2026

(54) METHODS AND APPARATUS FOR ENHANCED INTERPOLATION FILTERING

(71) Applicant: Telefonaktiebolaget LM Ericsson (publ), Stockholm (SE)

(72) Inventors: Kenneth ANDERSSON, GÄVLE (SE); Ruoyang YU, Täby (SE)

(73) Assignee: Telefonaktiebolaget LM Ericsson (publ), Stockholm (SE)

(21) Appl. No.: 19/120,281

(22) PCT Filed: Oct. 3, 2023
(86) PCT No.: PCT/SE2023/050982

§ 371 Date: Apr. 11, 2025

Related U.S. Application Data
(60) Provisional application No. 63/379,368, filed on Oct. 13, 2022.

(51) Int. Cl. H04N 19/117; H04N 19/105; H04N 19/132; H04N 19/172; H04N 19/176; H04N 19/51; H04N 19/593; H04N 19/80

(52) U.S. Cl. CPC H04N 19/117; H04N 19/105; H04N 19/132; H04N 19/172; H04N 19/176; H04N 19/51; H04N 19/593; H04N 19/80

(57) ABSTRACT

There is provided a method for encoding or decoding video The method comprises obtaining a first plurality of sample values of a reference block and applying a filter to the first plurality of sample values. The filter comprises a set of 12 coefficient values, and the set of coefficient values is selected from the following groups of coefficient values: {0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; {0, 1, −2, 4, −8, 17, 254, −14, 6, −3, 1, 0}; {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.

### TECHNICAL FIELD

Disclosed are embodiments related to filtering in video applications, and in particular, methods and apparatus for performing interpolation filtering for prediction, motion compensation, and/or upscaling.

### BACKGROUND

### Versatile Video Coding (VVC) and High Efficiency Video Coding (HVEC)

Versatile Video Coding (VVC) and its predecessor, High Efficiency Video Coding (HEVC), are block-based video codecs standardized and developed jointly by ITU-T and

MPEG. The codecs utilize both temporal and spatial prediction. Spatial prediction is achieved using intra (I) prediction from within the current picture. Temporal prediction is achieved using uni-directional (P) or bi-directional inter (B) prediction on the block level from previously decoded reference pictures. In the encoder, the difference between the original sample data and the predicted sample data, referred to as the residual, is transformed into the frequency domain, quantized, and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture. The VVC version 1 specification was published as Rec. ITU-T H.266 |ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### Video and Picture

In certain aspects, a video sequence may be comprised of a series of pictures. In VVC, each picture is identified with a picture order count (POC) value. The POC value can also represent display order of the picture. Typically, a picture with a smaller POC value is displayed before another picture with a larger POC value.

### Components

A video sequence comprises a series of pictures, where each picture comprises one or more components. A picture in a video sequence is sometimes denoted “image” or “frame.” Each component in a picture can be described as a two-dimensional rectangular array of sample values (or “samples” for short). It is common that a picture in a video sequence has three components: one luma component Y where the sample values are luma values; and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as “color components,” and other times as “channels.”

### Coding Units and Coding Blocks

In many video coding standards, such as HEVC and VVC, each component of a picture is split into blocks and the coded video bitstream consists of a series of coded blocks. A block is a two-dimensional array of samples, for instance. It is common in video coding that the picture is split into units that cover a specific area of the picture. In certain implementations, each unit comprises all blocks from all components that make up that specific area and each block belongs fully to one unit. The macroblock in H.264 and the Coding unit (CU) in HEVC and VVC are examples of units. In VVC, the CUs may be split recursively to smaller CUs. The CU at the top level is referred to as the coding tree unit (CTU). A CU usually contains three coding blocks-one coding block for luma and two coding blocks for chroma. The size of luma coding block is the same as the CU, and the maximum CU size (maxCUwidth) is signaled in a parameter set. In the current VVC (version 1), the CUs can have size of 4×4 up to 128×128.

### Parameter Sets, Slice Headers, and Picture Headers

VVC specifies three types of parameter sets: the picture parameter set (PPS), the sequence parameter set (SPS), and the video parameter set (VPS). The PPS contains data that is common for a whole picture, the SPS contains data that is common for a coded layer video sequence (CLVS), and the VPS contains data that is common for multiple CLVSs, such as data for multiple layers in the bitstream. The concept of slices divides the picture into independently coded slices, where decoding of one slice in a picture can be independent of other slices of the same picture. Typically, each slice has a slice header comprising syntax elements, and decoded slice header values from these syntax elements are used when decoding the slice. In VVC, a coded picture contains a picture header. The picture header contains parameters that are common for all slices of the coded picture.

### Intra Prediction

In intra prediction, also known as spatial prediction, a block is predicted using the previous decoded blocks within the same picture. The samples from the previously decoded blocks within the same picture are used to predict the samples inside the current block. A picture consisting of only intra-predicted blocks is sometimes referred to as an intra picture.

### Inter Prediction and Motion Compensation

In inter prediction, also known as temporal prediction, blocks of the current picture are predicted using blocks from previously decoded pictures. The samples from blocks in the previously decoded pictures are used to predict the samples inside the current block. A picture that allows inter-predicted blocks is sometimes referred to as an inter picture, with the previous decoded pictures used for inter prediction referred to as reference pictures.

The location of the referenced block inside the reference picture is indicated using a motion vector (MV). Each MV consists of x and y components, which represent the displacements between the current block and the referenced block in the x or y dimension. The value of a component may have a resolution finer than an integer position. When that is the case, a filtering (typically interpolation) can be done to calculate values used for prediction. FIG. 1A shows an example of a MV for the current block C. In this example, MV=(2, 1).

An inter picture may use several reference pictures. The reference pictures are usually put into two reference picture lists, L0 and L1. The reference pictures that are output before the current picture are typically the first pictures in L0. The reference pictures that are output after the current picture are typically the first pictures in L1. Inter predicted blocks can use different prediction types, including uni- and bi-prediction. Uni-predicted block predicts from one reference picture, either using L0 or L1. Bi-prediction predicts from two reference pictures, one from L0 and the other from L1. FIG. 1B shows an example of the prediction types. The prediction block generation process, which is based on the MVs, and the corresponding reference pictures, are often referred to as a motion compensation process.

### Fractional MVs, Interpolation Filter, and Motion Vector (MV) Rounding

The value of a MV's x or y component may correspond to a sample position that has finer granularity than an integer (sample) position. Those positions are also referred to as fractional (sample) positions. For instance, in VVC, the MV can be at 1/16 sample positions. FIG. 1C depicts several fractional positions in the horizontal (x-) dimension. The solid-square blocks represent integer positions and the circles represent 1/16-positions. For example, MV=(4, 10) can mean the x component is at 4/16 position, and the y component is at 10/16 position. In video coding, a MV rounding process is sometimes used to convert a MV at one position to another target position. One example of rounding is to round a fractional MV position to the nearest integer position. When a MV is at fractional position, filtering (typically interpolation) is done to calculate the sample values at those positions. In VVC, the length (number of filter taps) of the interpolation filter for the luma component is 8, as shown in the example of Table 1.

TABLE 1

| Fractional | | | | | | | | |
|---|---|---|---|---|---|---|---|---|
| sample | interpolation filter coefficients | | | | | | | |
| position p | f_{L}[ p ][ 0 ] | f_{L}[ p ][ 1 ] | f_{L}[ p ][ 2 ] | f_{L}[ p ][ 3 ] | f_{L}[ p ][ 4 ] | f_{L}[ p ][ 5 ] | f_{L}[ p ][ 6 ] | f_{L}[ p ][ 7 ] |
| 1 | 0 | 1 | −3 | 63 | 4 | −2 | 1 | 0 |
| 2 | −1 | 2 | −5 | 62 | 8 | −3 | 1 | 0 |
| 3 | −1 | 3 | −8 | 60 | 13 | −4 | 1 | 0 |
| 4 | −1 | 4 | −10 | 58 | 17 | −5 | 1 | 0 |
| 5 | −1 | 4 | −11 | 52 | 26 | −8 | 3 | −1 |
| 6 | −1 | 3 | −9 | 47 | 31 | −10 | 4 | −1 |
| 7 | −1 | 4 | −11 | 45 | 34 | −10 | 4 | −1 |
| 8 | −1 | 4 | −11 | 40 | 40 | −11 | 4 | −1 |
| 9 | −1 | 4 | −10 | 34 | 45 | −11 | 4 | −1 |
| 10 | −1 | 4 | −10 | 31 | 47 | −9 | 3 | −1 |
| 11 | −1 | 3 | −8 | 26 | 52 | −11 | 4 | −1 |
| 12 | 0 | 1 | −5 | 17 | 58 | −10 | 4 | −1 |
| 13 | 0 | 1 | −4 | 13 | 60 | −8 | 3 | −1 |
| 14 | 0 | 1 | −3 | 8 | 62 | −5 | 2 | −1 |
| 15 | 0 | 1 | −2 | 4 | 63 | −3 | 1 | 0 |

In this example, the filter gain is 64 (e.g. the sum of the coefficients is equal to 64), such that the filter response can be normalized by dividing by 64 or right shifting by 6 to have unity gain.

In VVC, an alternative filter can be used when the fractional sample position is at half-pel position (8/16). Compared to the half-pel filter in the previous table, the alternative half-pel filter has more low-pass property. The coefficients of the alternative half-pel filter are shown in Table 2.

TABLE 2

| Fractional | | | | | | | | |
|---|---|---|---|---|---|---|---|---|
| sample | interpolation filter coefficients | | | | | | | |
| position p | f_{L}[ p ][ 0 ] | f_{L}[ p ][ 1 ] | f_{L}[ p ][ 2 ] | f_{L}[ p ][ 3 ] | f_{L}[ p ][ 4 ] | f_{L}[ p ][ 5 ] | f_{L}[ p ][ 6 ] | f_{L}[ p ][ 7 ] |
| 8 | 0 | 3 | 9 | 20 | 20 | 9 | 3 | 0 |

Often, the procedure for filtering a block of samples is to first apply the filtering in the horizontal direction, and then the output of that process is filtered in the vertical direction. The final output can then be normalized (R) such that the filtering has unity gain, and filtering in the first stage can be down-shifted (P) to reduce the bit-depth of the second filtering. In certain aspects, filtering may comprise summing up the multiplications of the N filter coefficients with the decoded samples of a previous picture (reference picture r) according to the motion vector (mvX,mvY). An example is shown below of how one sample can be obtained from filtering using equations (i) and (ii). Before vertical filtering can be applied, it may be necessary to apply horizontal filtering for all samples that are needed for vertical filtering.

$$t ( x , y ) = ( {\sum }_{n = 0}^{N - 1} {f}_{i} ( n ) * r ( x + n - \frac{N}{2} + 1 + mvXInt , y + mvYInt ) ) ≫ P \qquad ( i )$$

$${r}^{″} ( x , y ) = ( {\sum }_{n = 0}^{N - 1} {f}_{j} ( n ) * t ( x , y + n - \frac{N}{2} + 1 ) ) ≫ R \qquad ( ii )$$

In these examples, t(x,y) is a sample after horizontal filtering, x is a horizontal coordinate and y is a vertical coordinate of the current picture, mvXInt and mvYInt are the motion vectors in integer resolution that are used to determine which samples in the reference picture are filtered, f_i is the sub-sample filter that corresponds to the fractional position (phase) of mvX, and f jis the sub-sample filter that corresponds to the fractional position (phase) of mvY. Additionally, r″(x,y) is a sample that has both been horizontally and vertically filtered, such as a sample of the inter prediction based on fractional sample interpolation of samples from a reference picture (e.g., a previously reconstructed picture).

### Residual, Transform, and Quantization

The difference between samples of a source block (containing original samples) and samples of the prediction block, also called residual block, is then typically compressed by a spatial transform to remove further redundancy. The transform coefficients are then quantized by a quantization parameter (QP) to control the fidelity of the residual block, and thus, also the bitrate required to compress the block. A coded block flag (CBF) can be used to indicate if there are any non-zero quantized transform coefficients. Typically, all coding parameters are then entropy coded at the encoder and decoded at the decoder. A reconstructed block can then be derived by inverse quantization and inverse transformation of the quantized transform coefficients if the coded block flag is one, and then add that to the prediction block.

### Hierarchy Picture Coding Structure

In random access configurations, intra coded pictures are positioned with a fixed interval (e.g., every second). Pictures between the intra picture are typically coded with a B-GOP (B-Group of Pictures) structure as shown in FIG. 1D. In this example, Picture 0 is coded first and then picture 8 is coded using picture 0 as its reference picture. Then picture 8 and picture 0 are used as reference pictures to code picture 4. Then similarly, picture 2 and picture 6 are coded, and finally, pictures 1, 3, 5 and 7 are coded. In certain respects, pictures 1, 3, 5, and 7 can be referred to as being on the highest hierarchical level, pictures 2, 4, and 6 to be on the next highest hierarchical level, picture 4 on next lowest level, and picture 8 on the lowest level. Typically picture 1, 3, 5 and 7 are not used for reference of any other pictures and are called non-reference pictures. The assigned QPs for each picture are usually different and are set according to the hierarchy level. A higher QP is usually assigned for pictures that are at a higher hierarchy level

### Inter Prediction/Motion Information

For an inter block inside an inter picture in VVC, for example, its inter prediction information may comprise the following three elements:
1. A reference picture list flag (RefPicListFlag). The flag signals which reference picture list is used for the block. When the value of the flag is equal to 0, it means only L0 is used for predicting the current block. When the value of the flag is equal to 1, it means only L1 is used for predicting the current block. When the value of the flag is equal to 2, it means both L0 and L1 are used for predicting the current block.
2. A reference picture index (RefPicIdx) per reference picture list used. The index signals which reference picture inside the reference list to be used for predicting the current block.
3. A motion vector (MV) per reference picture used. It signals the position inside the reference picture that is used for predicting the current block.

The inter prediction information is also referred to as motion information. In certain respects, the decoder stores the motion information for each inter block. In other words, an inter block can maintain its own motion information.

### Reference Picture Resampling (RPR)

Reference Picture Resampling (RPR) is a VVC tool that can be used to enable switching between different resolutions in a video bitstream without encoding a startup of a new sequence with an intra picture. This gives more flexibility to adapt resolution to control bitrate which can be of use in for example video conferencing or adaptive streaming. RPR can make use of previously encoded pictures of lower or higher resolution than the current picture to be encoded by re-scaling them to the resolution of the current picture as part of inter prediction of the current picture.

### SUMMARY

Certain challenges presently exist. For instance, one or more pictures may be encoded in a lower resolution than others, and require up-conversion. However, existing filters may be insufficient, and provide sub-optimal subjective and/or objective performance. This can include, for instance, one or more of ringing effects, poor peak signal-to-noise ratio (PSNR) for a particular bitrate, misalignments in phase or amplification fluctuations, etc. As another example, existing filters may be too short, leading to undesirable phase and/or magnitude responses across a given frequency range. Additionally, there are challenges in meeting accuracy demands. Thus, there remains a need for effective filters for prediction and motion compensation, as well as for combined prediction and re-scaling (e.g., upscaling) in certain applications.

Accordingly, in one aspect there is provided a method for encoding or decoding video, comprising: obtaining a first plurality of sample values of a reference block and applying a filter to the first plurality of sample values. The filter comprises a set of 12 coefficient values, and the set of coefficient values is selected from the following groups of coefficient values: {0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; {0, 1, −2, 4, −8, 17, 254, −14, 6, −3, 1, 0}; {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.

In some aspects, there is provided a computer program comprising instructions which when executed by processing circuitry of an apparatus (e.g., an encoder or decoder) causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided a video processing apparatus that is configured to perform the methods disclosed herein. The apparatus may include memory and processing circuitry coupled to the memory.

An advantage of embodiments disclosed herein is that they provided filter sets that can achieve, in certain aspects, improved objective and/or subject performance. According to some embodiments, interpolation filters are provided with accurate phase and improved magnitude properties for use in interpolation, for instance, as part of motion compensated prediction in video coding and/or for upscaling to higher resolution. In some embodiments, the filters may be used for accurate upscaling to higher resolution while at the same time performing motion compensation (e.g. RPR motion compensation). In certain aspects, the filters can be used at least for one color component, and benefits may be observed with improved performance (e.g., achieving a target PSNR at a reduced bitrate).

### BRIEF DESCRIPTION OF THE DRAWINGS

The accompanying drawings, which are incorporated herein and form part of the specification, illustrate various embodiments.

FIG. 1A illustrates an example of a motion vector.

FIG. 1B illustrates an example of prediction types.

FIG. 1C depicts examples of fractional positions a motion vector.

FIG. 1D illustrates an example of a Group of Pictures (e.g., a four-layer B-GOP structure using two reference pictures per picture).

FIG. 2 illustrates a system according to an embodiment.

FIG. 3 is a schematic block diagram of an encoder according to an embodiment.

FIG. 4 is a schematic block diagram of a decoder according to an embodiment.

FIG. 5A illustrates a phase delay response of an 8-tap filter and FIG. 5B illustrates a magnitude response of the 8-tap filter.

FIG. 6A illustrates a phase delay response of a 12-tap filter and FIG. 6B illustrates a magnitude response of the 12-tap filter.

FIG. 7A illustrates a phase delay response of a 12-tap filter according to embodiments, and FIG. 7B illustrates a magnitude response of the filter.

FIG. 8A illustrates a phase delay response of a 12-tap filter according to embodiments, and FIG. 8B illustrates a magnitude response of the filter.

FIG. 9 is a flowchart illustrating a process according to an embodiment.

FIG. 10 is a block diagram of an apparatus according to an embodiment.

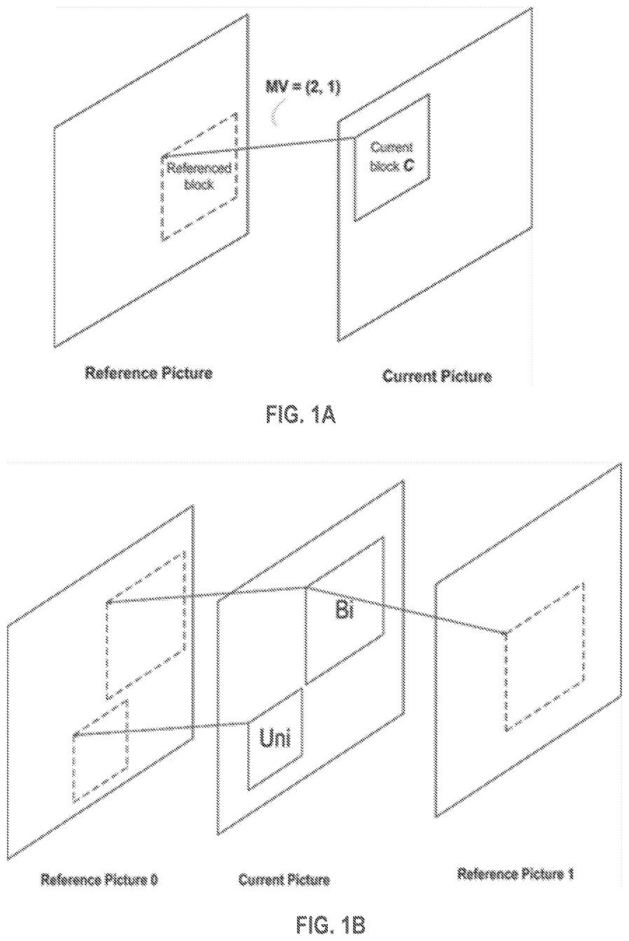

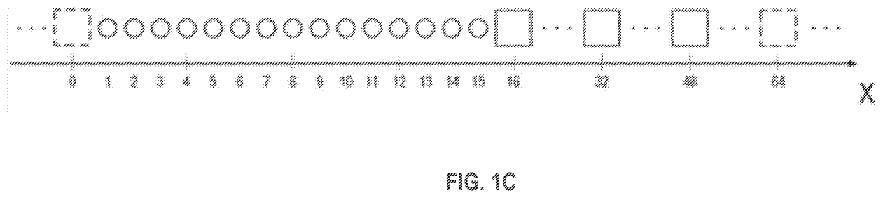

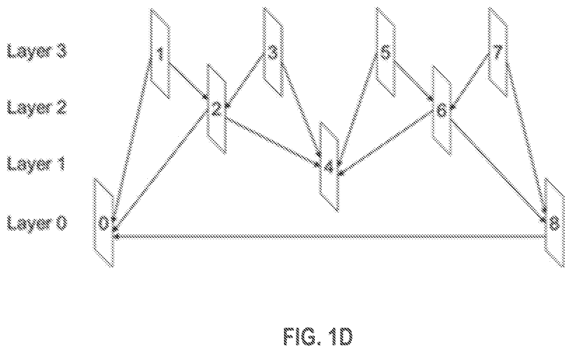

### DETAILED DESCRIPTION

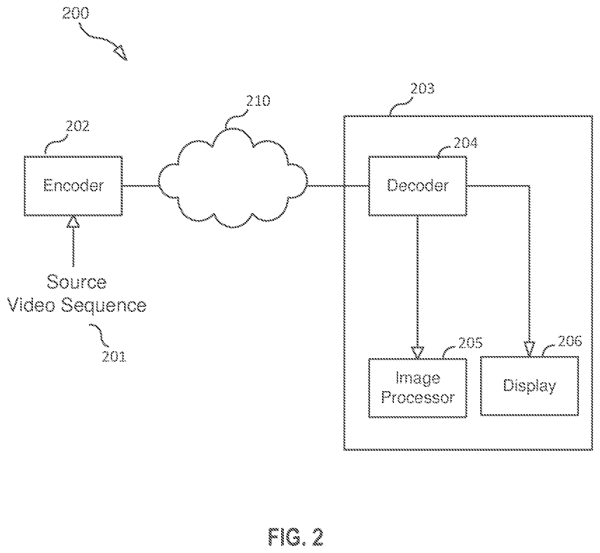

FIG. 2 illustrates a system 200 according to an embodiment. System 200 includes an encoder 202 and a decoder 204, wherein encoder 202 is in communication with decoder 204 via a network 210 (e.g., the Internet or other network). Encoder 202 encodes a source video sequence 201 into a bitstream comprising an encoded video sequence and transmits the bitstream to decoder 204 via network 210. In some embodiments, encoder 202 is not in communication with decoder 204, and, in such an embodiment, rather than transmitting bitstream to decoder 204, the bitstream is stored in a data storage unit. Decoder 204 decodes the pictures included in the encoded video sequence to produce video data for display and/or further image processing (e.g. a machine vision task). Accordingly, decoder 204 may be part of a device 203 having an image processor 205 and/or a display 206. The image processor 205 may perform machine vision tasks on the decoded pictures. One such machine vision task may be identifying objects in the picture. The image processor 205 may also perform image enhancements on the decoded picture. The image processor 205 may use a neural network-based algorithm for the image enhancements. In some embodiments, the device 203 may be a mobile device, a set-top device, a head-mounted display, or any other device.

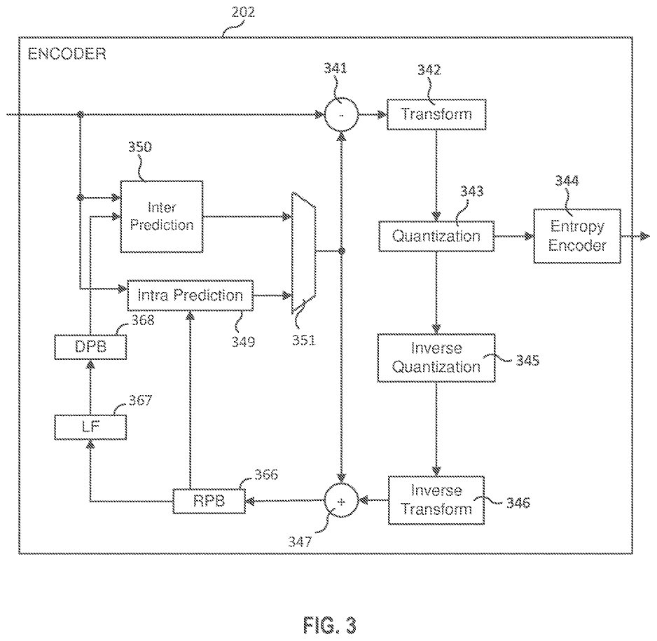

FIG. 3 illustrates functional components of an encoder 202 according to some embodiments. It should be noted that encoders may be implemented differently, so implementation other than this specific example can be used. Encoder 202 employs a subtractor 341 to produce a residual block which is the difference in sample values between an input block and a prediction block (i.e., the output of a selector 351, which is either an inter prediction block output by an inter predictor 350 (a.k.a., motion compensator) or an intra prediction block output by an intra predictor 349). Then a forward transform 342 is performed on the residual block to produce a transformed block comprising transform coefficients. A quantization unit 343 quantizes the transform coefficients based on a quantization parameter (QP) value (e.g., a QP value obtained based on a picture QP value for the picture in which the input block is a part and a block specific QP offset value for the input block), thereby producing quantized transform coefficients which are then encoded into the bitstream by encoder 344 (e.g., an entropy encoder) and the bitstream with the encoded transform coefficients is output from encoder 202. Next, encoder 202 uses the quantized transform coefficients to produce a reconstructed block. This is done by first applying inverse quantization 345 and inverse transform 346 to the transform coefficients to produce a reconstructed residual block and using an adder 347 to add the prediction block to the reconstructed residual block, thereby producing the reconstructed block, which is stored in the reconstruction picture buffer (RPB) 366. Loop filtering by a loop filter (LF) stage 367 is applied and the final decoded picture is stored in a decoded picture buffer (DPB) 368, where it can then be used by the inter predictor 350 to produce an inter prediction block for the next picture to be processed. LF stage 367 may include three sub-stages: (i) a deblocking filter, (ii) a sample adaptive offset (SAO) filter, and (iii) an Adaptive Loop Filter (ALF).

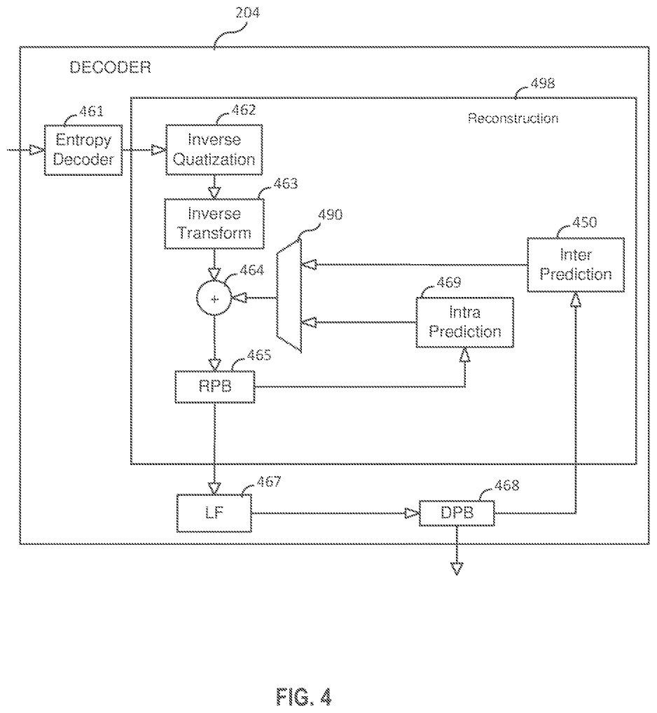

FIG. 4 illustrates functional components of decoder 204 according to some embodiments. It should be noted that decoder 204 may be implemented differently so implementations other than this specific example can be used. Decoder 204 includes a decoder module 461 (e.g., an entropy decoder) that decodes from the bitstream quantized transform coefficient values of a block. Decoder 204 also includes a reconstruction stage 498 in which the quantized transform coefficient values are subject to an inverse quantization process 462 and inverse transform process 463 to produce a residual block. This residual block is input to adder 464 that adds the residual block and a prediction block output from selector 490 to form a reconstructed block. Selector 490 either selects to output an inter prediction block or an intra prediction block. The reconstructed block is stored in a RPB 465. The inter prediction block is generated by the inter prediction module 450 and the intra prediction block is generated by the intra prediction module 469. Following the reconstruction stage 498, a loop filter stage 467 applies loop filtering and the final decoded picture may be stored in a decoded picture buffer (DPB) 468 and output to image processor 205. Pictures may be stored in the DPB for two primary reasons: (1) to wait for picture output; and (2) to be used for reference when decoding future pictures.

As described above, a challenge presently exists because, for instance, some of the pictures may be encoded in a lower resolution compared to other pictures in a coded video stream when RPR is enabled. As example, in a coded video stream some of the pictures are encoded in 720p resolution while the other pictures are encoded in 1080p resolution. When decoding such a coded video stream, some reconstructed pictures that are coming out from the decoder will be in 720p resolution (since they were encoded in that resolution) while the other reconstructed pictures that are coming out from the decoder will be in the 1080p resolution. In some cases, those 720p reconstructed pictures need to be upscaled to also be at the 1080p resolution for displaying or viewing purposes.

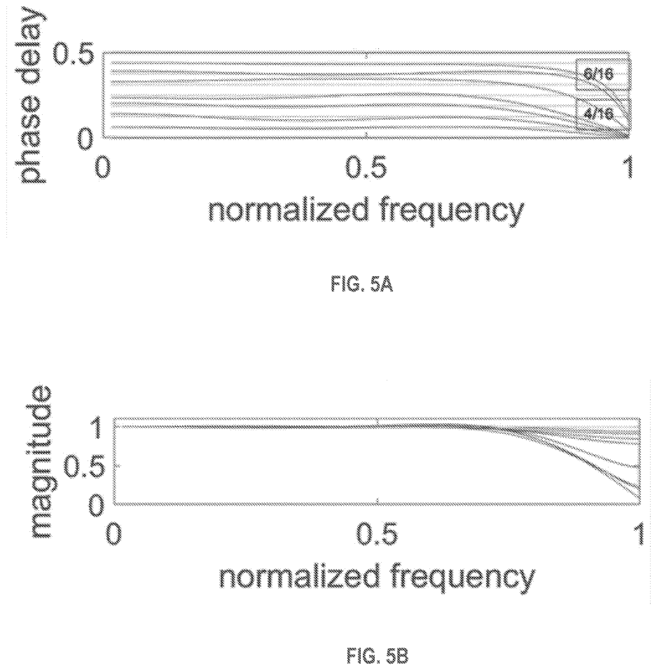

In VTM (the reference software for the VVC standard), the upscaling filters that are used for upscaling the low-resolution reconstructed pictures are the 8-tap interpolation filters used in the motion compensation process. FIGS. 5A and 5B show the phase and magnitude response of the VVC 8-tap filters. As can be seen in FIG. 5A, there are phase misalignments at lower frequencies. Another problem with the upscaling filters used in VTM is that the number of filter taps is relatively short. This can result in a sub-optimal magnitude property. As shown in FIG. 5B, suppressions of high frequencies are observed in the magnitude response. Furthermore, those suppression begin to occur at mid-high frequency range, which is also not optimal.

In the current enhanced compression model (ECM), the motion compensation filters (e.g., the interpolation filters used in the motion compensation process) have been increased to 12-tap from 8-tap. However, the upscaling filters for upscaling low-resolution reconstructed pictures under the RPR scenario, for instance, remain as 8-tap for luma. A test was performed by replacing those 8-tap upscaling filters with the 12-tap motion compensation filters in ECM. A similar test was also performed with VTM, where the 8-tap luma upscaling filters were replaced with the 12-tap ECM luma motion compensation filters and the 4-tap chroma upscaling filters replaced with 6-tap ECM chroma motion compensation filters. Improvements of objective performance (e.g., measured based on PSNR values comparing upscaled reconstructed pictures to the original pictures) were noticed, as shown in Tables 3 and 4 below. Table 3 illustrates the results of VTM RPR 1.5× (upscaling) with the 12-tap ECM luma MC filter (12tap_ecm) and Table 4 illustrates the results of VTM RPR 2× (upscaling) with the 12-tap ECM luma MC filter (12tap_ecm), with the percentage values indicating the bitrate reduction for a given PSNR.

TABLE 3

| | Low delay B Main10 | | |
|---|---|---|---|
| | Over VTM-18.0 RPR 1.5x | | |
| | Y | U | V |
| Class B | −1.28% | −1.28% | −1.24% |
| Class C | −1.51% | −1.83% | −1.82% |
| Class E | −3.72% | −1.37% | −0.75% |
| Overall | −1.96% | −1.49% | −1.31% |
| Class D | −1.27% | −1.43% | −1.89% |
| Class F | −1.63% | −3.99% | −4.31% |

TABLE 4

| | Low delay B Main10 | | |
|---|---|---|---|
| | Over VTM-18.0 RPR 2x | | |
| | Y | U | V |
| Class B | −1.49% | −1.70% | −1.76% |
| Class C | −0.87% | −2.06% | −2.01% |
| Class E | −2.47% | −2.57% | −1.57% |
| Overall | −1.53% | −2.04% | −1.79% |
| Class D | −0.68% | −1.55% | −2.08% |
| Class F | −0.99% | −3.11% | −3.53% |

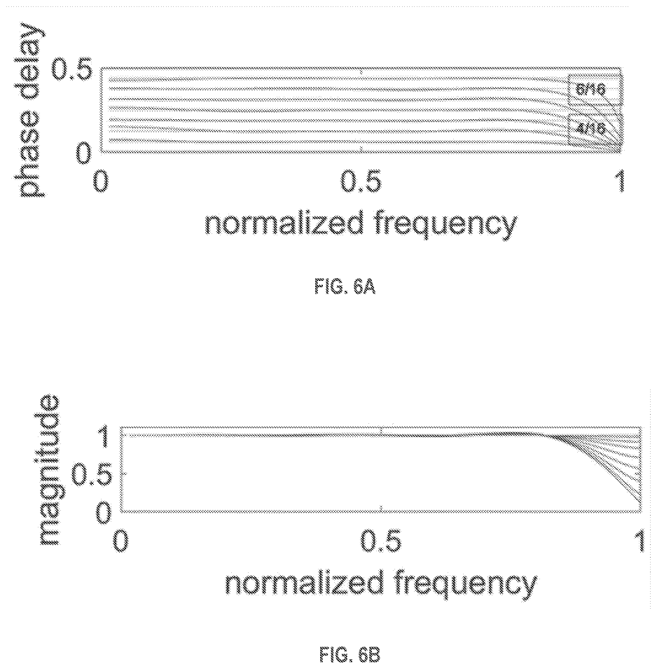

However, besides some additional fidelity some ringing artifacts in upscaled reconstructed pictures were also observed. Moreover, FIGS. 6A and 6B show the phase and magnitude response of the 12-tap ECM motion compensation filters. It can be observed that there are some phase misalignments occurring at lower frequencies in FIG. 6A. Additionally, some degrees of fluctuation and amplification of mid-high frequencies can be seen in the magnitude response of FIG. 6B. The filter coefficients {--} for this example, with corresponding phase n/16, are provided below:
0 {0, 0, 0, 0, 0, 256, 0, 0, 0, 0, 0, 0},
1 {−1, 2, −3, 6, −14, 254, 16, −7, 4, −2, 1, 0},
2 {−1, 3, −7, 12, −26, 249, 35, −15, 8, −4, 2, 0},
3 {−2, 5, −9, 17, −36, 241, 54, −22, 12, −6, 3, −1},
4 {−2, 5, −11, 21, −43, 230, 75, −29, 15, −8, 4, −1},
5 {−2, 6, −13, 24, −48, 216, 97, −36, 19, −10, 4, −1},
6 {−2, 7, −14, 25, −51, 200, 119, −42, 22, −12, 5, −1},
7 {−2, 7, −14, 26, −51, 181, 140, −46, 24, −13, 6, −2},
8 {−2, 6, −13, 25, −50, 162, 162, −50, 25, −13, 6, −2},
9 {−2, 6, −13, 24, −46, 140, 181, −51, 26, −14, 7, −2},
10 {−1, 5, −12, 22, −42, 119, 200, −51, 25, −14, 7, −2},
11 {−1, 4, −10, 19, −36, 97, 216, −48, 24, −13, 6, −2},
12 {−1, 4, −8, 15, −29, 75, 230, −43, 21, −11, 5, −2},
13 {−1, 3, −6, 12, −22, 54, 241, −36, 17, −9, 5, −2},
14 {0, 2, −4, 8, −15, 35, 249, −26, 12, −7, 3, −1},
15 {0, 1, −2, 4, −7, 16, 254, −14, 6, −3, 2, −1}.
   As shown above, in this example, some coefficients have relatively large negative magnitudes, which may cause ringing artifacts (e.g., close to sharp edges).

According to embodiments, improved filter coefficients of lengths 12 (or 12-tap) are provided. They may be used, for example, for interpolation of a phase corresponding to one of n/16 where n is from 1 to 16. According to embodiments, however, different phases and/or steps may be used. In certain aspects, the filters can be used for motion compensated prediction for one color component, R G B or for luma or chroma components. The filters can also be used for upscaling a picture to higher resolution. According to embodiments, two sets of interpolation filters are provided, which are referred to as “12tapA” and “12tapB” in the examples. The filters of embodiments described herein can provide objective and/or subjective benefits in video coding for motion compensated prediction with sub-sample accuracy, for upscaling low-resolution pictures to higher resolution, or both.

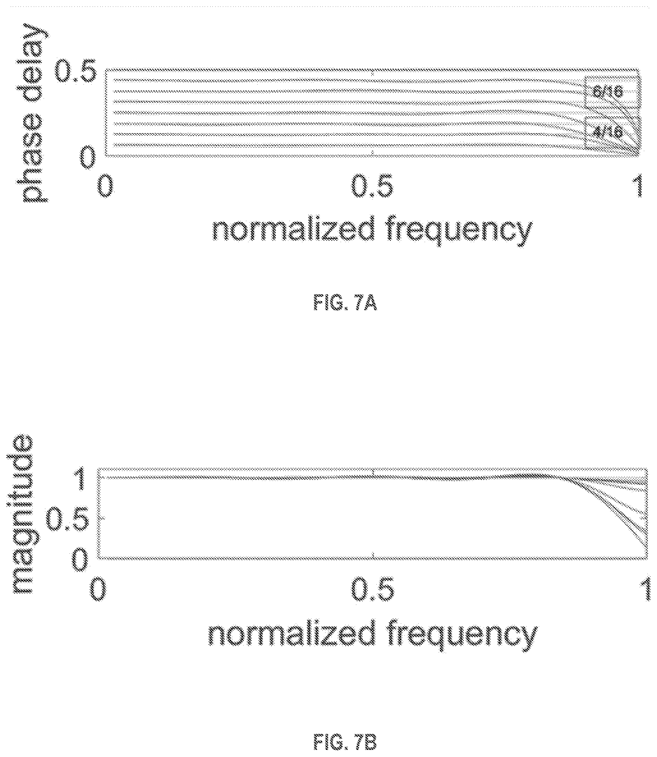

According to embodiments, examples of the phase and magnitude responses for the 12tapA filters are illustrated in FIGS. 7A and 7B. The 12 filter coefficients for the n/16 phases (phase 0 to 15) are shown below for the 12tapA filter set:
0 {0, 0, 0, 0, 0, 256, 0, 0, 0, 0, 0, 0},
1 {0, 1, −3, 6, −14, 254, 17, −8, 4, −2, 1, 0},
2 {−2, 4, −7, 13, −27, 250, 35, −15, 8, −4, 2, −1},
3 {−2, 6, −11, 19, −38, 244, 51, −19, 9, −4, 1, 0},
4 {−4, 9, −15, 25, −47, 234, 72, −26, 13, −6, 2, −1},
5 {−4, 9, −14, 24, −48, 216, 97, −37, 21, −12, 7, −3},
6 {−4, 8, −13, 25, −50, 198, 121, −44, 25, −15, 9, −4},
7 {−5, 11, −17, 29, −54, 184, 138, −45, 24, −13, 7, −3},
8 {−4, 9, −15, 27, −51, 162, 162, −51, 27, −15, 9, −4},
9 {−3, 7, −13, 24, −45, 138, 184, −54, 29, −17, 11, −5},
10 {−4, 9, −15, 25, −44, 121, 198, −50, 25, −13, 8, −4},
11 {−3, 7, −12, 21, −37, 97, 216, −48, 24, −14, 9, −4},
12 {−1, 2, −6, 13, −26, 72, 234, −47, 25, −15, 9, −4},
13 {0, 1, −4, 9, −19, 51, 244, −38, 19, −11, 6, −2},
14 {−1, 2, −4, 8, −15, 35, 250, −27, 13, −7, 4, −2},
15 {0, 1, −2, 4, −8, 17, 254, −14, 6, −3, 1, 0}.
   According to embodiments, these filters can perform close to the ideal phase, especially at lower frequencies.

Tests have been carried out in VTM where the 8-tap upscaling filters were replaced with the 12tapA filters according to embodiments. The objective impacts are shown in the Table 5 and Table 6 below. Table 5 illustrates VTM RPR 1.5× with the improved 12-tap filter (12tapA) and Table 6 illustrates VTM RPR 2× with the improved 12-tap filter (12tapA).

TABLE 5

| | Low delay B Main10 | | |
|---|---|---|---|
| | Over VTM-18.0 RPR 1.5x | | |
| | Y | U | V |
| Class B | −1.23% | −1.28% | −1.24% |
| Class C | −1.71% | −1.83% | −1.82% |
| Class E | −4.04% | −1.37% | −0.75% |
| Overall | −2.09% | −1.49% | −1.31% |
| Class D | −1.43% | −1.43% | −1.89% |
| Class F | −1.81% | −3.99% | −4.31% |

TABLE 6

| | Low delay B Main10 | | |
|---|---|---|---|
| | Over VTM-18.0 RPR 2x | | |
| | Y | U | V |
| Class B | −1.71% | −1.70% | −1.76% |
| Class C | −1.00% | −2.06% | −2.01% |
| Class E | −2.85% | −2.57% | −1.57% |
| Overall | −1.76% | −2.04% | −1.79% |
| Class D | −0.78% | −1.55% | −2.08% |
| Class F | −1.11% | −3.11% | −3.53% |

When compared with the results of Table 3 and Table 4, the 12tapA filters give better compression performance than the ECM 12-tap MC filters when used for upscaling reconstructed pictures. This is shown, for instance, with the results for the Y (luma) components. In some embodiments, additional processing is performed after the filtering using this set, such as a (de-ringing) post filter in upscale scenarios, or when used for prediction in video coding that later has residual coding by transforms and loop filtering.

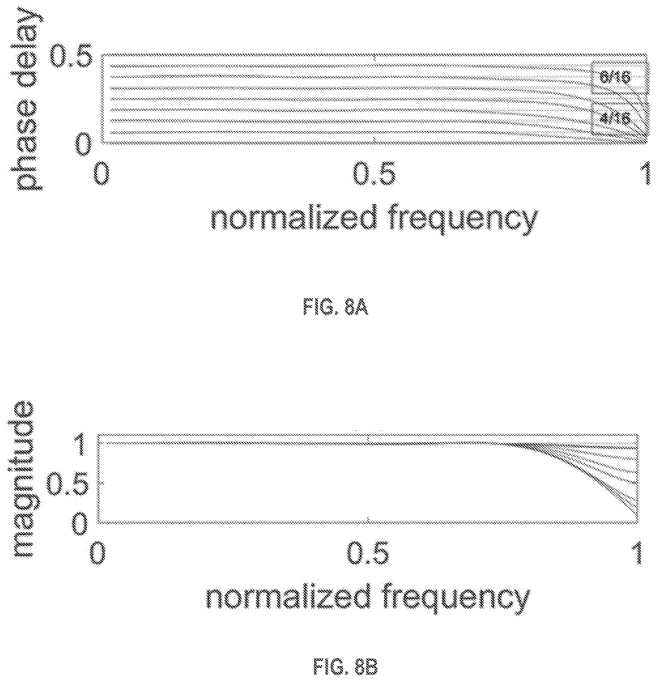

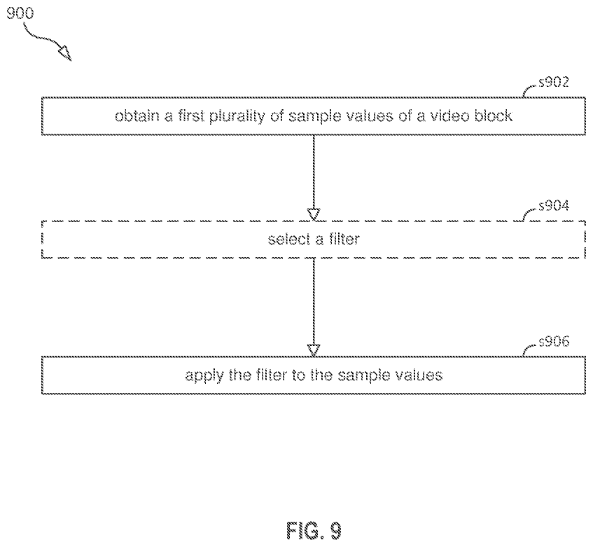

Another filter set, 12tapB, is also provided according to embodiments. In certain aspects, the 12tapB filter may be especially useful in applications that are subjective quality oriented and/or in the case that there is no additional processing after the filter before displaying the picture. In some embodiments, the 12tapB set may be used for higher QP processing (e.g., low bitrate coding and/or coarse quantization in the residual coding), or when the QP of a reference picture or reference area is smaller than the QP of the current block (e.g., to reduce ringing after filtering of a current block if there are relatively sharp edges in the reference block). A QP threshold may be used in some embodiments. An example value is 37; however, other values may be used. The phase and magnitude responses for the 12tapB filters are shown in FIGS. 8A and 8B, according to embodiments. The 12 filter coefficients for the n/16 phases (phase 0 to 15) are shown below for the 12tapB filter set:
0 {0, 0, 0, 0, 0, 256, 0, 0, 0, 0, 0, 0},
1 {1, −1, 0, 3, −12, 253, 16, −6, 2, 0, 0, 0},
2 {0, 0, −3, 9, −24, 250, 32, −11, 4, −1, 0, 0},
3 {0, 0, −4, 12, −32, 241, 52, −18, 8, −4, 2, −1},
4 {0, 1, −6, 15, −38, 228, 75, −28, 14, −7, 3, −1},
5 {0, 1, −7, 18, −43, 214, 96, −33, 16, −8, 3, −1},
6 {1, 0, −6, 17, −44, 196, 119, −40, 20, −10, 4, −1},
7 {0, 2, −9, 21, −47, 180, 139, −43, 20, −10, 4, −1},
8 {−1, 3, −9, 21, −46, 160, 160, −46, 21, −9, 3, −1},
9 {−1, 4, −10, 20, −43, 139, 180, −47, 21, −9, 2, 0},
10 {−1, 4, −10, 20, −40, 119, 196, −44, 17, −6, 0, 1},
11 {−1, 3, −8, 16, −33, 96, 214, −43, 18, −7, 1, 0},
12 {−1, 3, −7, 14, −28, 75, 228, −38, 15, −6, 1, 0},
13 {−1, 2, −4, 8, −18, 52, 241, −32, 12, −4, 0, 0},
14 {0, 0, −1, 4, −11, 32, 250, −24, 9, −3, 0, 0},
15 {0, 0, 0, 2, −6, 16, 253, −12, 3, 0, −1, 1,}.

According to embodiments, these filters perform close to the ideal phase, especially at lower frequencies. Furthermore, comparing to the magnitude response of the 12 tap ECM MC filter in FIG. 6B, the magnitude response of the 12tapB filters have less fluctuations (i.e, are “flatter”) and provide less amplification of high frequencies. In certain aspects, the filter coefficients have less negative magnitude, especially further away from the center of the filter. This can, in some embodiments, reduce ringing.

Tests have been carried out in VTM where the 8-tap upscaling filters were replaced with the proposed 12tapB filters. The proposed 12tapB filters provide less ringing artifacts than the ECM 12-tap MC filters when used for upscaling reconstructed pictures. The objective impacts are shown in the Table 7 and Table 8 below. Table 7 illustrates VTM RPR 1.5× with the proposed 12-tap filter (12tapB) and Table 8 illustrates VTM RPR 2× with the proposed 12-tap filter (12tapB).

TABLE 7

| | Low delay B Main10 | | |
|---|---|---|---|
| | Over VTM-18.0 RPR 1.5x | | |
| | Y | U | V |
| Class B | −0.58% | −1.28% | −1.24% |
| Class C | −0.68% | −1.83% | −1.82% |
| Class E | −2.02% | −1.37% | −0.75% |
| Overall | −0.97% | −1.49% | −1.31% |
| Class D | −0.58% | −1.43% | −1.89% |
| Class F | −0.88% | −3.99% | −4.31% |

TABLE 8

| | Low delay B Main10 | | |
|---|---|---|---|
| | Over VTM-18.0 RPR 2x | | |
| | Y | U | V |
| Class B | −0.79% | −1.70% | −1.76% |
| Class C | −0.44% | −2.06% | −2.01% |
| Class E | −1.30% | −2.57% | −1.57% |
| Overall | −0.80% | −2.04% | −1.79% |
| Class D | −0.36% | −1.55% | −2.08% |
| Class F | −0.45% | −3.11% | −3.53% |

According to embodiments, the filtering may be applied in a video encoder or video decoder. The described filter sets can be used as interpolation filters in motion compensation process, and can also be used for upscaling pictures to higher resolution. In some embodiments, they can be used for upscaling to higher resolution while at the same time providing motion compensation, such as RPR motion compensation.

According to some embodiments, the 12-tap filter set “12tapA” is used for standard motion compensation, for example, when the picture resolution and the reference picture resolution are the same. This may be beneficial, for instance, where the picture may be subject to further processing. Additionally, the 12tapA filter set may be especially useful in high-accuracy application. In some embodiments, it can also be used for motion compensation in RPR scenarios (e.g., when the picture resolution ratio between the reference picture and the current picture is less than a certain threshold, for example 1 or 1.25). In some embodiments, this set is used for cases when the reference picture has a picture resolution smaller than the current picture. Moreover, the filters can also be used for upscaling a low-resolution picture to a higher resolution. For example, for upscaling the low-resolution reconstructed pictures.

According to some embodiments, the 12-tap filter set “12tapB” is used for upscaling a low-resolution picture to a higher resolution, especially when subjective quality is of concern and/or there is no additional processing before displaying the high-resolution picture. However, according to embodiments, the proposed filter can also be used in the normal motion compensation (i.e., when the picture resolution and the reference picture resolution are the same). It can also be used for motion compensation in RPR scenarios, including when the picture resolution ratio between the reference picture and the current picture is less than a certain threshold, for example 1 or 1.25. In other words, for cases when the reference picture having a picture resolution smaller than the current picture.

Applications for both filter sets may include, for instance, interpolation, constant phase, motion compensation, inter prediction, intra prediction, sub-sample accuracy, and/or video coding, according to embodiments.

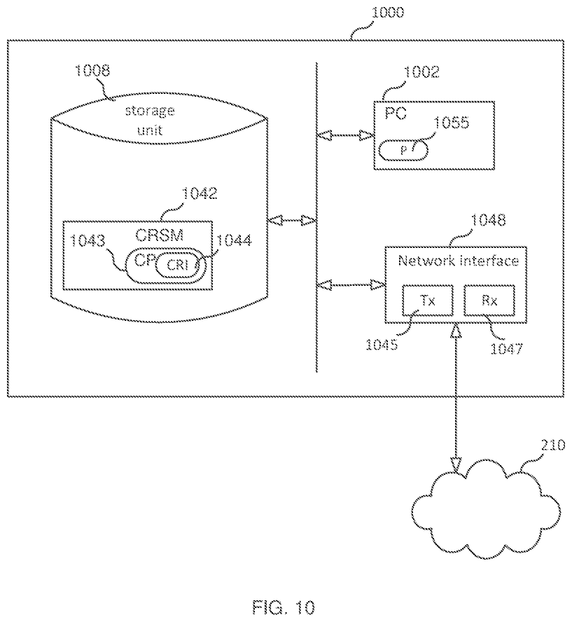

FIG. 9 is a flowchart illustrating a process 900 for video processing, such as encoding or decoding, according to some embodiments. The process 900 may be used, for example, by an apparatus such as encoder 202, decoder 204, or apparatus 1000 in FIG. 10. In some embodiments, the process 900 is a process for motion compensated prediction, inter prediction, intra prediction, upscaling, and/or RPR. However, process 900—including use of the filter sets described herein—may be used in other applications.

Process 900 may begin in step s902 according to some embodiments. Step 902 comprises obtaining a first plurality of sample of a first video block, such as a reference block. In step 904, which may be optional in some embodiments, a filter or filter coefficient values are selected. In step 906, the filter is applied to the first plurality of samples, for instance, to generate a second plurality of sample values for a second video block (e.g., a current block). This may comprise interpolating the first plurality of sample values to give sample values at positions other than the positions of the first plurality of sample values (e.g., in-between the samples in x-direction or y-direction or both). According to embodiments, the filter comprises a set of 12 coefficient values, such as a set of coefficient values selected from the 12-tap filter set 12tapA or 12tapB. The selection of a particular filter or set could be performed, for instance, on the encoder side and signaled to the decoder. It could also be selected by the encoder and/or decoder, for example, based on the analysis of samples in a first or reference picture.

In some embodiments, the first block may be from a first video picture (e.g., a reference picture) and the second block from a second video picture (e.g., a current picture). Additionally, the first and second blocks/pictures may have different resolutions. Thus, the filter that is used in process 900 may be based, at least in part, on a determination of the respective resolutions or their difference (e.g., ratio). As an example, a first filter or filter type could be used for normal motion compensation when the resolutions are the same, while a second, different filter or filter type is used for upscaling and/or RPR. According to embodiments, the determination could be based on a threshold. For instance, if the scaling ratio is 1, one set of filter coefficients is used (for example the ECM filters). But if the ratio is greater than 1.25 as an example (current resolution is 1.25 greater in at least one dimension than the reference resolution), then another filter is used in that dimension, such as 12tapA or 12tapB. Other thresholds/ratios may be used, such as 1.5× or 2×.

According to some embodiments, the phase is determined. This may be, for example, as part of step 904. However, it could be performed in other instances, including as another part of process 900. In some embodiments, for upscaling scenarios the phase is derived from a scaling ratio (e.g., the ratio between reference and current picture resolution). In some embodiments, in normal motion compensation when the resolution is same, the phase is derived based on rate distortion cost. In certain aspects, the “phase” can be signaled via the motion vector or inherited from a neighboring block. The decoder can then derive the MV and perform prediction. In some embodiments, such as RPR, there is a combination of both. However, similar to normal motion compensation, the phase can be selected based on rate distortion cost and signaled via the motion vector or inherited from a neighboring block. The decoder then derives the MV and performs prediction.

FIG. 10 is a block diagram of an apparatus 1000 for implementing encoder 202 and/or decoder 204, according to some embodiments. When apparatus 1000 implements encoder 202, apparatus 1000 may be referred to as an encoder apparatus, and when apparatus 1000 implements decoder 204, apparatus 1000 may be referred to as a decoder apparatus. As shown in FIG. 10, apparatus 1000 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., encoder apparatus 1000 may be a distributed computing apparatus); at least one network interface 1048 (e.g., a physical interface or air interface) comprising a transmitter (Tx) 1045 and a receiver (Rx) 1047 for enabling apparatus 1000 to transmit data to and receive data from other nodes connected to a network 210 (e.g., an Internet Protocol (IP) network) to which network interface 1048 is connected (physically or wirelessly) (e.g., network interface 1048 may be coupled to an antenna arrangement comprising one or more antennas for enabling encoder apparatus 1000 to wirelessly transmit/receive data); and a storage unit (a.k.a., “data storage system”) 1008, which may include one or more non-volatile storage devices and/or one or more volatile storage devices. In embodiments where PC 1002 includes a programmable processor, a computer readable storage medium (CRSM) 1042 may be provided. CRSM 1042 may store a computer program (CP) 1043 comprising computer readable instructions (CRI) 1044. CRSM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes encoder apparatus 1000 to perform steps described herein (e.g., steps described herein with reference to the flow charts). In other embodiments, encoder apparatus 1000 may be configured to perform steps described herein without the need for code. That is, for example, PC 1002 may consist merely of one or more ASICs. Hence, the features of the embodiments described herein may be implemented in hardware and/or software.

### Summary of Various Embodiments

A1. A method (900) for encoding or decoding video, comprising:
obtaining (s902) a first plurality of sample values of a first video block (e.g., a reference block); and
applying (s906) a filter to the first plurality of sample values,
wherein the filter comprises a set of 12 coefficient values, and the set of coefficient values is selected from the following groups of coefficient values:
   {0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; {0, 1, −2, 4, −8, 17, 254, −14, 6, −3, 1, 0};
   {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.
A2. The method of embodiment A1, wherein applying the filter comprises generating a second plurality of sample values for a second video block (e.g., a current block).
A3. The method of embodiment A1 or A2, further comprising:
selecting (s904) the filter or filter coefficient values.
A4. The method of any of embodiments A1-A3, the method comprising performing one or more of a motion compensated prediction, an inter prediction, an intra prediction, and an upscaling using the first plurality of sample values,
wherein performing one or more of the motion compensated prediction, the inter prediction, the intra prediction, and the upscaling comprises applying the filter to interpolate the first plurality of sample values.
A5. The method of any of embodiments A1-A4, the method comprising performing Reference Picture Resampling, RPR, wherein performing RPR comprises applying the filter to interpolate the first plurality of sample values.
A6. The method of any of embodiments A1-A5, where each of the groups of coefficient values correspond to a phase value (e.g., a value of n ranging from 0 to 15).
A7. The method of any of embodiments A1-A6, wherein the selected filter or coefficient values is based at least in part on a determined phase value (e.g., based on a scaling ratio between pictures or a value of a motion vector) for one or more of prediction, motion compensation, or upscaling.
A8. The method of any of embodiments A1-A7, wherein the selected coefficient values correspond to a phase of 0 (e.g., for duplication) or 8 (e.g., for additional positions in 2× upscaling).
A9. The method of any of embodiments A1-A8, wherein at least one of the first plurality of sample values or second plurality of sample values is located at a fractional sample position.
A10. The method of any of embodiments A2-A9, wherein selecting the filter or filter coefficient values is based at least in part on:
   (i) the sample position (e.g., phase) of at least one of the first plurality of sample values compared to the corresponding sample position of at least one of the second plurality of sample values (e.g. phase), and/or
   (ii) an x or y component of a motion vector (e.g., motion between the first and the second video block).
A11. The method of any of embodiments A6-A10, wherein the sample position or phase value is any of 0/16, 1/16, 2/16, 3/16, . . . , 15/16.
A12. The method of any of embodiments A2-A11, wherein the first block is from a first video picture (e.g., a reference picture) and the second block is from a second video picture (e.g., a current picture).
A13. The method of embodiment A12, wherein the first and second video pictures have the same resolution (e.g., where the filter is applied for prediction and/or motion compensation without upscaling).
A14. The method of embodiment A13, wherein the filter coefficient values are selected from the following groups of coefficient values:
   {0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; or {0, 1, −2, 4, −8, 17, 254, −14, 6, −3, 1, 0}.
A15. The method of embodiment A13, wherein the filter coefficient values are selected from the following groups of coefficient values:
   {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.
A16. The method of embodiment A12, wherein the first picture has a first resolution and the second picture has a second, different resolution (e.g., where the filter is applied, at least in part, for upscaling).
A17. The method of embodiment A16, wherein the second resolution is higher than the first resolution and the filter is used for motion compensation (e.g., RPR).
A18. The method of embodiment A16, wherein the filter coefficient values are selected from:
   {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.
A19. The method of embodiment A16 or A17, wherein the filter coefficient values are selected from:
   {0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; or {0, 1, −2, 4, −8, 17, 254, −14, 6, −3, 1, 0}.
A20. The method of any of embodiments A12-A19, further comprising:
determining a difference (e.g., ratio) between a resolution of the second video picture and a resolution of the first video picture,
wherein selecting the filter or filter coefficients, or applying the filter, is based at least in part on the determining.
A21. The method of embodiment A20, wherein the difference is greater than a threshold (e.g., greater than a ratio of 1, such as a reference picture being half the resolution of a current picture (2×) or being 2/3 the resolution of a current picture (1.5×)).
A22. The method of A20 or A21, wherein
   (i) for a difference that is less than or equal to a threshold (e.g., less than or equal to 1), a first set of coefficients is applied (e.g., selected from the ECM filter sets); and
   (ii) for a difference that is greater than or equal to a threshold (e.g., greater than 1), a second, different set of coefficients is applied.
A23. The method of A22, wherein the second set of coefficients is selected from:
   {0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; {0, 1, −2, 4, −8, 17, 254, −14, 6, −3, 1, 0};
   {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.
A24. The method of any of embodiments A2-A23, wherein the first and second blocks are from the same video picture.
A25. The method of any of embodiments A1-A24, wherein the applied filter is an interpolation filter.
A26. The method of any of embodiments A2-A25, wherein the first and second plurality of sample values are luma or chroma values.
A27. The method of any of embodiments A1-A26, wherein the encoding or decoding comprises encoding or decoding at low bitrates and/or a quantization parameter (QP) (e.g., for a picture, slice, or block of the first plurality of samples) that is greater than or equal to a threshold, the set of coefficient values is selected from the following groups of coefficient values:
   {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.
A28. The method of any of A2-A27, wherein a QP of a video picture for the first block is smaller than a QP of a video picture of the second block, the set of coefficient values is selected from the following groups of coefficient values (e.g., to reduce ringing due to sharp edges in the first block):
   {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.
B1. A computer program (1043) comprising instructions (1044) which when executed by processing circuitry (1002) of an apparatus (1000) causes the apparatus to perform the method of any one of the above embodiments.
B2. A carrier containing the computer program of embodiment B1, wherein the carrier is one of an electronic signal, an optical signal, a radio signal, and a computer readable storage medium (1042).
C1. An apparatus (202, 204) for video processing, the apparatus being configured to:
obtain a first plurality of sample values of a first video block (e.g., a reference block); and
apply a filter to the first plurality of sample values,
wherein the filter comprises a set of 12 coefficient values, and the set of coefficient values is selected from the following groups of coefficient values:
   {0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; {0, 1, −2, 4, −8, 17, 254, −14, 6, −3, 1, 0};
{0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-31. (canceled)

32. A method for encoding or decoding video, comprising:
obtaining a first plurality of sample values of a reference block;
selecting a filter or a plurality of filter coefficient values for the filter; and
applying the filter to the first plurality of sample values,
wherein applying the filter comprises generating a second plurality of sample values for a current block,
wherein the filter comprises a set of 12 coefficient values, and the set of coefficient values is selected from the following groups of coefficient values:
{0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; {0, 1, −2, 4, −8, 17, 254, −14, 6, −3, 1, 0}; {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.

33. The method of claim 32, further comprising performing one or more of a motion compensated prediction, an inter prediction, an intra prediction, and an upscaling using the first plurality of sample values, wherein performing one or more of the motion compensated prediction, the inter prediction, the intra prediction, and the upscaling comprises applying the filter to interpolate the first plurality of sample values.

34. The method of claim 32, further comprising performing Reference Picture Resampling (RPR), wherein performing RPR comprises applying the filter to interpolate the first plurality of sample values.

35. The method of claim 32, where each of the groups of coefficient values correspond to a phase value.

36. The method of claim 32, wherein the selected filter or filter coefficient values is based at least in part on a determined phase value for one or more of prediction, motion compensation, or upscaling.

37. The method of claim 32, wherein the selected coefficient values correspond to a phase of 0 or 8.

38. The method of claim 32, wherein at least one of the first plurality of sample values or second plurality of sample values is located at a fractional sample position.

39. The method of claim 32, wherein selecting the filter or filter coefficient values is based at least in part on:
(i) the sample position of at least one of the first plurality of sample values compared to the corresponding sample position of at least one of the second plurality of sample values, and/or
(ii) an x or y component of a motion vector.

40. The method of claim 32, wherein the reference block is from a reference picture and the current block is from a current picture, wherein the reference and current pictures have the same resolution.

41. The method of claim 32, wherein the reference block is from a reference picture and the current block is from a current picture, wherein the reference picture has a first resolution and the current picture has a second, different resolution, wherein the second resolution is higher than the first resolution and the filter is used for motion compensation.

42. The method of claim 41, further comprising:
determining a difference between a resolution of the current picture and a resolution of the reference picture,
wherein selecting the filter or filter coefficients, or applying the filter, is based at least in part on the determining.

43. The method of claim 32, wherein the reference and current blocks are from the same video picture.

44. The method of claim 32, wherein the applied filter is an interpolation filter.

45. A non-transitory computer readable storage medium storing a computer program comprising instructions which when executed by processing circuitry of an apparatus causes the apparatus to perform the method of claim 32.

46. An apparatus for video processing, the apparatus comprising:
memory; and
processing circuitry, wherein the apparatus is configured to:
obtain a first plurality of sample values of a reference block;
select a filter or a plurality of filter coefficient values for the filter; and
apply the filter to the first plurality of sample values,
wherein applying the filter comprises generating a second plurality of sample values for a current block,
wherein the filter comprises a set of 12 coefficient values, and the set of coefficient values is selected from the following groups of coefficient values:
{0, 0, 0, 0, 0, 256, 0, 0, 0, 0, 0, 0}; {0, 1, −3, 6, −14, 254, 17, −8, 4, −2, 1, 0}; {−2, 4, −7, 13, −27, 250, 35, −15, 8, −4, 2, −1}; {−2, 6, −11, 19, −38, 244, 51, −19, 9, −4, 1, 0}; {−4, 9, −15, 25, −47, 234, 72, −26, 13, −6, 2, −1}; {−4, 9, −14, 24, −48, 216, 97, −37, 21, −12, 7, −3}; {−4, 8, −13, 25, −50, 198, 121, −44, 25, −15, 9, −4}; {−5, 11, −17, 29, −54, 184, 138, −45, 24, −13, 7, −3}; {−4, 9, −15, 27, −51, 162, 162, −51, 27, −15, 9, −4}; {−3, 7, −13, 24, −45, 138, 184, −54, 29, −17, 11, −5}; {−4, 9, −15, 25, −44, 121, 198, −50, 25, −13, 8, −4}; {−3, 7, −12, 21, −37, 97, 216, −48, 24, −14, 9, −4}; {−1, 2, −6, 13, −26, 72, 234, −47, 25, −15, 9, −4}; {0, 1, −4, 9, −19, 51, 244, −38, 19, −11, 6, −2}; {−1, 2, −4, 8, −15, 35, 250, −27, 13, −7, 4, −2}; {0, 1, −2, 4, −8, 17, 254, −14, 6, −3, 1, 0}; {0, 0, 0, 0, 0, 256, 0, 0, 0, 0, 0, 0}; {1, −1, 0, 3, −12, 253, 16, −6, 2, 0, 0, 0}; {0, 0, −3, 9, −24, 250, 32, −11, 4, −1, 0, 0}; {0, 0, −4, 12, −32, 241, 52, −18, 8, −4, 2, −1}; {0, 1, −6, 15, −38, 228, 75, −28, 14, −7, 3, −1}; {0, 1, −7, 18, −43, 214, 96, −33, 16, −8, 3, −1}; {1, 0, −6, 17, −44, 196, 119, −40, 20, −10, 4, −1}; {0, 2, −9, 21, −47, 180, 139, −43, 20, −10, 4, −1}; {−1, 3, −9, 21, −46, 160, 160, −46, 21, −9, 3, −1}; {−1, 4, −10, 20, −43, 139, 180, −47, 21, −9, 2, 0}; {−1, 4, −10, 20, −40, 119, 196, −44, 17, −6, 0, 1}; {−1, 3, −8, 16, −33, 96, 214, −43, 18, −7, 1, 0}; {−1, 3, −7, 14, −28, 75, 228, −38, 15, −6, 1, 0}; {−1, 2, −4, 8, −18, 52, 241, −32, 12, −4, 0, 0}; {0, 0, −1, 4, −11, 32, 250, −24, 9, −3, 0, 0}; or {0, 0, 0, 2, −6, 16, 253, −12, 3, 0, −1, 1,}.
